(19) United States
(12) Patent Application Publication
(10) Pub. No.: US 2016/0366615 A1
(43) Pub. Date: Dec. 15, 2016

(54) SYSTEMS AND METHODS FOR SELECTIVE FLOW CONTROL

(71) Applicant: QUALCOMM Incorporated, San Diego, CA (US)

(72) Inventors: Bhaskara Viswanadham Batchu, Hyderabad (IN); Rohit Joshi, Haldwani (IN)

(21) Appl. No.: 14/740,159

(22) Filed: Jun. 15, 2015

(51) Int. Cl. H04W 28/10; H04L 12/859; H04L 12/851; H04L 12/801; H04W 36/22

(52) U.S. Cl. CPC H04W 28/10; H04L 47/14; H04W 36/22; H04L 47/2483; H04L 47/2475; H04W 88/02

(57) ABSTRACT

Systems, methods, apparatuses, and media are provided for selective application of flow control in a user equipment supporting a plurality of radio access technologies. A determination may be made as to whether a flow control condition is met. A subset of a the plurality of radio access technologies may be selected in response to determining that the flow control condition is met. Flow control may be applied to the radio access technologies of the selected subset.

### BACKGROUND

1. Field

Embodiments described herein generally relate to systems and methods for selective application of flow control.

2. Background

A user equipment (“UE”), such as a mobile phone device, may be enabled for one or more radio access technologies (“RATs”), such as Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, or other protocols that may be used in a wireless communications network or a data communications network. One or more RATs may be enabled by one, or a plurality of subscriber identity modules (“SIMs”). For example, a UE may be a multi-SIM UE, where each of a plurality of SIMs received or otherwise coupled to the multi-SIM UE may support one or more RATs.

### SUMMARY

Various embodiments relate to systems and methods for selective application of flow control.

According to some embodiments, a method for performing selective flow control in a user equipment supporting a plurality of radio access technologies is provided. The method includes determining whether a flow control condition is met. The method further includes selecting a subset of the plurality of radio access technologies, in response to determining that the flow control condition is met. The method further includes applying flow control to the radio access technologies of the selected subset.

According to some embodiments, the subset of the plurality of radio access technologies does not include all the radio access technologies of the plurality of radio access technologies.

According to some embodiments, applying flow control to the radio access technologies of the selected subset comprises changing a data rate used for the radio access technologies of the selected subset.

According to some embodiments, the flow control condition is based on a state of a hardware component of the user equipment.

According to some embodiments, the flow control condition is not based on a throughput value for any one or more of the plurality of radio access technologies.

According to some embodiments, the flow control condition is based on a parameter of the user equipment.

According to some embodiments, the parameter of the user equipment is a usage capacity of a processor of the user equipment.

According to some embodiments, the parameter of the user equipment is a usage level of a memory device of the user equipment.

According to some embodiments, the parameter of the user equipment is a thermal value for the user equipment.

According to some embodiments, selecting the subset of the plurality of radio access technologies comprises selecting the subset based on a base station loading level for each of the plurality of radio access technologies.

According to some embodiments, selecting the subset based on a base station loading level for each of the plurality of radio access technologies comprises selecting a radio access technology from the plurality of radio access technologies that has a lowest value for a ratio of actual throughput to requested throughput.

According to some embodiments, selecting the subset of the plurality of radio access technologies comprises selecting the subset based on volume of data in a queue of the user equipment for each of the plurality of radio access technologies.

According to some embodiments, selecting the subset based on volume of data in a queue of the user equipment for each of the plurality of radio access technologies comprises selecting a radio access technology from the plurality of radio access technologies that has a highest volume of data in a transmit queue of the user equipment.

According to some embodiments, selecting the subset of the plurality of radio access technologies comprises selecting the subset based on one or more channel quality metrics for each of the plurality of radio access technologies.

According to some embodiments, selecting the subset based on one or more channel quality metrics for each of the plurality of radio access technologies comprises selecting a radio access technology from the plurality of radio access technologies that has poorest values for the one or more channel quality metrics as compared to values for the one or more channel quality metrics for the remaining radio access technologies of the plurality of radio access technologies.

According to some embodiments, the one or more channel quality metrics for each of the plurality of radio access technologies comprises a packet error rate for each of the plurality of radio access technologies.

According to some embodiments, the one or more channel quality metrics for each of the plurality of radio access technologies comprises an acknowledge (ACK)/negative-acknowledge (NAK) rate for each of the plurality of radio access technologies.

According to some embodiments, the one or more channel quality metrics for each of the plurality of radio access technologies comprises a retransmission rate for each of the plurality of radio access technologies.

According to some embodiments, the method further includes registering each radio access technology of the plurality of radio access technologies for flow control.

According to some embodiments, the method further includes transmitting a flow control down command. In such embodiments, the flow control down command instructs the selected subset of radio access technologies to reduce a data rate.

According to some embodiments, the method further includes transmitting a flow control off command. In such embodiments, the flow control off command instructs the selected subset of radio access technologies to remove restrictions on the data rate.

According to some embodiments, the method further includes determining whether the flow control condition is still met after said applying flow control to the radio access technologies of the selected subset.

According to some embodiments, the method further includes selecting a second subset of the plurality of radio access technologies, in response to determining that the flow control condition is still met.

According to some embodiments, the method further includes applying flow control to the radio access technologies of the selected second subset.

According to some embodiments, determining whether a flow control condition is met is performed without coordination by a base station of any one or more of the plurality of radio access technologies.

According to some embodiments, a user equipment apparatus supporting a plurality of radio access technologies is provided. The user equipment apparatus includes one or more processors configured to determine whether a flow control condition is met. The one or more processors are further configured to select a subset of the plurality of radio access technologies, in response to determining that the flow control condition is met. The one or more processors are further configured to apply flow control to the radio access technologies of the selected subset.

According to some embodiments, a user equipment apparatus supporting a plurality of radio access technologies is provided. The user equipment apparatus includes means for determining whether a flow control condition is met. The user equipment apparatus further includes means for selecting a subset of the plurality of radio access technologies, in response to determining that the flow control condition is met. The user equipment apparatus further includes means for applying flow control to the radio access technologies of the selected subset.

According to some embodiments, a non-transitory computer-readable medium for use with a user equipment supporting a plurality of radio access technologies is provided. The non-transitory computer-readable medium includes instructions configured to cause one or more computing devices to determine whether a flow control condition is met. The medium includes instructions configured to cause one or more computing devices to select a subset of the plurality of radio access technologies, in response to determining that the flow control condition is met. The medium includes instructions configured to cause one or more computing devices to apply flow control to the radio access technologies of the selected subset.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram illustrating an example of a system according to various embodiments.

FIG. 2 is a functional block diagram illustrating an example of a user equipment according to various embodiments.

FIG. 3 is a schematic diagram illustrating an example of a user equipment according to various embodiments.

FIG. 4 is a flowchart of a process according to various embodiments.

FIG. 5 is a flowchart of a process according to various embodiments.

FIG. 6 is a flowchart of a process according to various embodiments.

FIG. 7 is a flowchart of a process according to various embodiments.

FIG. 8 is a flowchart of a process according to various embodiments.

FIG. 9 is a flowchart of a process according to various embodiments.

FIG. 10 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claim.

Various modern communication devices are described herein. Such a modern communication device may be referred to herein as a user equipment (“UE”). However, such a modern communication device may also be referred to as a mobile station (“MS”), a wireless device, a communications device, a wireless communications device, a mobile device, a mobile phone, a mobile telephone, a cellular device, a cellular telephone, and in other ways. Examples of UE include, but are not limited to, mobile phones, laptop computers, smart phones, and other mobile communication devices of the like that are configured to connect to one or more RATs.

Some UE may contain one or more subscriber identity modules (“SIMs”) that provide users of the UEs with access to one or multiple separate mobile networks, supported by radio access technologies (“RATs”). Examples of RATs may include, but are not limited to, Global Standard for Mobile (“GSM”), Code Division Multiple Access (“CDMA”), CDMA2000, Time Division-Code Division Multiple Access (“TD-CDMA”), Time Division-Synchronous Code Division Multiple Access (“TD-SCDMA”), Wideband-Code Division Multiple Access (“W-CDMA”), Time Division Multiple Access (“TDMA”), Frequency Division Multiple Access (“FDMA”), Long-Term Evolution (“LTE”), wireless fidelity (“Wi-Fi”), various 3G standards, various 4G standards, and the like.

Embodiments described herein relate to both single-SIM and multi-SIM UEs. A UE that includes a plurality of SIMs and connects to two or more separate RATs using a same set of RF resources (e.g., radio-frequency (“RF”) transceivers) is a multi-SIM-multi-standby (“MSMS”) communication device. In one example, the MSMS communication device may be a dual-SIM-dual-standby (“DSDS”) communication device, which may include two SIM cards/subscriptions that may both be active on standby, but one is deactivated when the other one is in use. In another example, the MSMS communication device may be a triple-SIM-triple-standby (“TSTS”) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

Further, a UE that includes a plurality of SIMs and connects to two or more separate mobile networks using two or more separate sets of RF resources is termed a multi-SIM-multi-active (“MSMA”) communication device. An example MSMA communication device is a dual-SIM-dual-active (“DSDA”) communication device, which includes two SIM cards/subscriptions, each associated with a separate RAT, where both SIMs may remain active at any given time. In another example, the MSMA device may be a triple-SIM-triple-active (“TSTA”) communication device, which includes three SIM cards/subscriptions, each associated with a separate RAT, where all three SIMs may remain active at any given time. In other examples, the MSMA communication device may be other suitable multi-SIM communication devices, with, for example, four or more SIMs, such that all SIMs are active at any given time.

In addition, a plurality of modes is enabled by one SIM, such that each mode may correspond to a separate RAT. Such a SIM is a multi-mode SIM. A UE may include one or more multi-mode SIMs. The UE may be a MSMS communication device (such as, but not limited to, a DSDS or a TSTS communication device), a MSMA communication device (e.g., a DSDA, TSTA communication device, or the like), or a multi-mode device.

As used herein, UE refers to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device that include one or more SIMs, a programmable processor, memory, and circuitry for connecting to one or more mobile communication networks (simultaneously or sequentially). Various embodiments may be useful in mobile communication devices, such as smart phones, and such devices are referred to in the descriptions of various embodiments. However, the embodiments may be useful in any electronic device, such as a DSDS, a TSTS, a DSDA, a TSTA communication device (or other suitable multi-SIM, multi-mode devices), that may individually maintain one or more subscriptions that utilize one or a plurality of separate set of RF resources.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the UE to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein are directed to improved techniques for the application of flow control. In particular, some communications environments may implement a technique of flow control within a UE. Based on various conditions that may occur within the UE, the UE may force all supported radio access technologies to reduce the data rate presently being used by those radio access technologies. This device-wide reduction in data rate for all supported radio access technologies may be effective to improve some condition (e.g., CPU capacity, memory capacity, thermal level) within the UE. Once the condition is improved, the reduction in data rate may be removed, allowing the various supported radio access technologies to again use any data rate selected by each of those radio access technologies.

However, conventional techniques for the application of flow control may be flawed for various reasons. First, conventional techniques may not effectively target the cause of a poor device condition. Namely, a poor device condition (e.g., CPU usage at maximum level) may not be caused equally by all supported radio access technologies. Instead, one or more radio access technologies may be contributing a larger portion to the poor device condition than are one or more other radio access technologies. Therefore, by causing all radio access technologies to reduce their respective data rates, the conventional techniques for the application of flow control may punish radio access technologies that are not contributing to the poor device condition to a significant degree. Second, based on this inability to target any particular radio access technology for data rate reduction, conventional techniques for the application of flow control may cause an inefficient and unnecessary undulation between a poor device condition (and thus data rate reduction) and an improved device condition (and thus no data rate reduction). Because conventional techniques do not effectively target the one or more radio access technologies contributing most significantly to the poor device condition, the device-wide reduction of data rate for all radio access technologies may cause the problematic one or more radio access technologies to temporarily improve the device condition, but then immediately impair that condition once again as soon as the data rate reduction is terminated.

Various embodiments described herein provide an improved technique for flow control by allowing selective application of flow control. In particular, when a UE supports multiple radio access technologies, techniques described herein may allow the selection of a subset of all supported radio access technologies for the application of flow control. In some cases, a UE may select one or more radio access technologies for a reduction in data rate based on the expectation that those selected radio access technologies are contributing most significantly to a poor device condition. For example, if a device condition is the percentage usage of the CPU, and the device condition is in a poor state when the value is greater than or equal to 95 percent, then the UE may choose either a supported voice RAT or a supported data RAT for a reduction in data rate. The UE may select only the data RAT for a reduction in data rate if the UE determines that the data RAT is contributing more significantly to the high level of CPU usage. This selective application of data rate reduction may allow the voice RAT to continue to operate normally while still improving the poor device condition presently and potentially for a longer period of time into the future.

In various embodiments described herein, different techniques may be used to select the subset of one or more radio access technologies for application of flow control. In some embodiments, the UE may select the subset of one or more radio access technologies based on the relative base station loading levels for each of the supported radio access technologies. In some embodiments, the UE may select the subset of one or more radio access technologies based on the volume of data in a queue for each of the supported radio access technologies. In some embodiments, the UE may select the subset of one or more radio access technologies based on channel quality metrics for each of the supported radio access technologies.

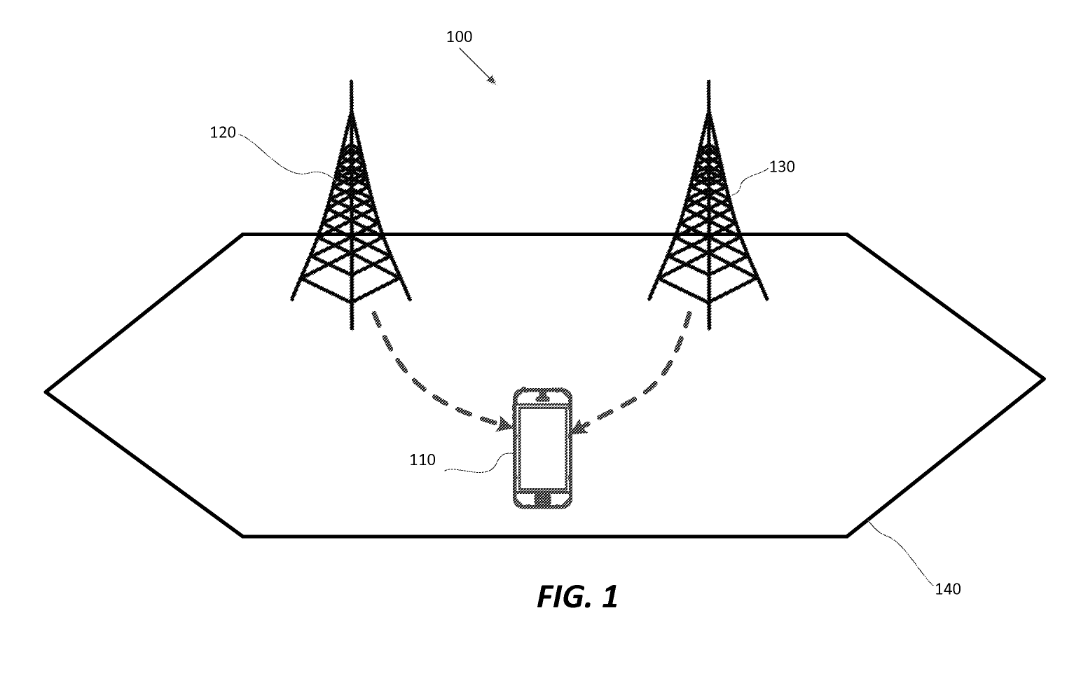

With reference to FIG. 1, a schematic diagram of a system 100 is shown in accordance with various embodiments. The system 100 may include a UE 110, a first base station 120, and a second base station 130. In some embodiments, each of the first base station 120 and the second base station 130 may represent a separate RAT, such as GSM, CDMA, CDMA2000, TD-CDMA, TD-SCDMA, W-CDMA, TDMA, FDMA, LTE, Wi-Fi, various 3G standards, various 4G standards, and/or the like. In other words, the first base station 120 may represent a first RAT, and the second base station may represent a second RAT, where the first RAT and the second RAT are different RATs. By way of illustrating with a non-limiting example, the first base station 120 may be transmitting W-CDMA while the second base station 130 may be transmitting GSM. In some embodiments, each RAT may be transmitted by the associated base station at different physical locations (i.e., the first base station 120 and the second base station 130 may be at different locations). In other embodiments, each RAT may be transmitted by the associated base station at the same physical location (i.e., the first base station 120 and the second base station 130 may be physically joined, or the base stations are the same base station).

The first base station 120 and the second base station 130 may each include at least one antenna group or transmission station located in the same or different areas, where the at least one antenna group or transmission station may be associated with signal transmission and reception. The first base station 120 and the second base station 130 may each include one or more processors, modulators, multiplexers, demodulators, demultiplexers, antennas, and the like for performing the functions described herein. In some embodiments, the first base station 120 and the second base station 130 may be utilized for communication with the UE 110 and may be an access point, Node B, evolved Node B (eNode B or eNB), base transceiver station (BTS), or the like.

A cell 140 may be an area associated with the first base station 120 and the second base station 130, such that the UE 110, when located within the cell 140, may connect to or otherwise access both the first and second RATs, as supported by the first base station 120 and the second base station 130 (e.g., receive signals from and transmit signals to the first base station 120 and the second base station 130), respectively. The cell 140 may be a defined area, or may refer to an undefined area in which the UE 110 may access the RATs supported by the base stations 120, 130.

In various embodiments, the UE 110 may be configured to access the RATs from the first base station 120 and/or the second base station 130 (e.g., receive/transmit signals of the first and/or the second RAT from/to the first base station 120 and/or the second base station 130). The UE 110 may be configured to access the RATs by virtue of the multi-SIM and/or the multi-mode SIM configuration of the UE 110 as described, such that when a SIM corresponding to a RAT is received, the UE 110 may be allowed to access that RAT, as provided by the associated base station.

In general, an acquisition process of a RAT refers to the process in which the UE 110 searches and acquires various communication protocols of the RAT in order to acquire and establish communication or traffic with the target base node that is broadcasting the RAT. Some communication protocols include synchronization channels, such as, but not limited to, primary synchronization channel (“P-SCH”), secondary synchronization channel (“S-SCH”), common pilot channel (“CPICH”), and the like. The target base nodes are nodes that transmit, broadcast, or otherwise support the particular RAT being acquired. In some embodiments, the first base station 120 may be a target base node for the first RAT, given that the first RAT may be transmitted by the first base station 120 as described. Thus, when the UE 110 initiates an acquisition process of the first RAT (as supported by the first base station 120), a communication channel is set for future communication and traffic between the UE 110 and the first base station 120. Similarly, the second base station 130 may be a target base node for the second RAT, which is transmitted by the second base station 130 as described. Thus, when the UE 110 initiates an acquisition process of the second RAT, a communication channel is set for future communication and traffic between the UE 110 and the second base station 130. The acquisition process may be initiated when the UE 110 seeks to initially access the RAT, or, after attaching to an initial RAT, to identify candidate target RAT (that is not the initial RAT) for a handover.

It should be appreciated by one of ordinary skill in the art that FIG. 1 and its corresponding disclosure are for illustrative purposes, and that the system 100 may include three or more base stations. In some embodiments, three or more base stations may be present, where each of the three or more base stations may represent (i.e., transmits signals for) one or more separate RATs in the manner such as, but not limited to, described herein.

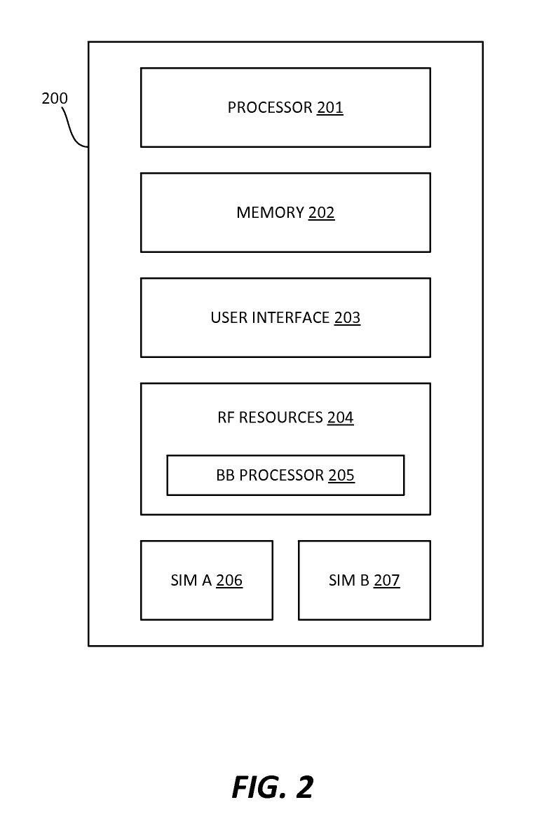

FIG. 2 is a functional block diagram of a UE 200 suitable for implementing various embodiments. According to various embodiments, the UE 200 may be the same or similar to the UE 110 as described with reference to FIG. 1. With reference to FIGS. 1-2, the UE 200 may include at least one processor 201, memory 202 coupled to the processor 201, a user interface 203, RF resources 204, and one or more SIMs (as denoted SIM A 206 and SIM B 207).

The processor 201 may include any suitable data processing device, such as a general-purpose processor (e.g., a microprocessor), but in the alternative, the processor 201 may be any suitable electronic processor, controller, microcontroller, or state machine. The processor 201 may also be implemented as a combination of computing devices (e.g., a combination of a DSP and a microprocessor, a plurality of microprocessors, at least one microprocessor in conjunction with a DSP core, or any other such configuration). The memory 202 may be operatively coupled to the processor 201 and may include any suitable internal or external device for storing software and data for controlling and use by the processor 201 to perform operations and functions described herein, including, but not limited to, random access memory RAM, read only memory ROM, floppy disks, hard disks, dongles or other USB connected memory devices, or the like. The memory 202 may store an operating system (“OS”), as well as user application software and executable instructions. The memory 202 may also store application data, such as an array data structure.

The user interface 203 may include a display and a user input device. In some embodiments, the display may include any suitable device that provides a human-perceptible visible signal, audible signal, tactile signal, or any combination thereof, including, but not limited to a touchscreen, LCD, LED, CRT, plasma, or other suitable display screen, audio speaker or other audio generating device, combinations thereof, and the like. In various embodiments, the user input device may include any suitable device that receives input from the use, the user input device including, but not limited to one or more manual operator (such as, but not limited to a switch, button, touchscreen, knob, slider or the like), microphone, camera, image sensor, and the like.

The processor 201 and the memory 202 may be coupled to the RF resources 204. In some embodiments, the RF resources 204 may be one set of RF resources such that only one RAT may be supported by the set of RF resources at any given time. In other embodiments, the RF resources may be a plurality of sets of RF resources such that each set may support one RAT at a given time, thus enabling the UE 200 to support multiple RATs simultaneously, (e.g., in a MSMA case). The RF resources 204 may include at least one baseband-RF resource chain (with which each SIM in the UE 200, e.g., the SIM A 206 and the SIM B 207, may be associated). The baseband-RF resource chain may include a baseband modem processor 205, which may perform baseband/modem functions for communications on at least one SIM, and may include one or more amplifiers and radios. In some embodiments, baseband-RF resource chains may share the baseband modem processor 205 (i.e., a single device that performs baseband/modem functions for all SIMs on the UE 200). In other embodiments, each baseband-RF resource chain may include physically or logically separate baseband processors 205.

The RF resources 204 may include transceivers that perform transmit/receive functions for the associated SIM of the UE 200. The RF resources 204 may include separate transmit and receive circuitry, such as a separate transmitter and receiver, or may include a transceiver that combines transmitter and receiver functions. The RF resources 204 may each be coupled to a wireless antenna.

In some embodiments, the processor 201, the memory 202, and the RF resources 204 may be included in the UE 200 as a system-on-chip. In some embodiments, the one or more SIMs (e.g., SIM A 206 and SIM B 207) and their corresponding interfaces may be external to the system-on-chip. Further, various input and output devices may be coupled to components on the system-on-chip, such as interfaces or controllers.

The UE 110 is configured to receive one or more SIMs (e.g., SIM A 206 and SIM B 207), an example of which is described herein. A SIM in various embodiments may be a Universal Integrated Circuit Card (UICC) that is configured with SIM and/or USIM applications, enabling access to various RAT networks as described. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In some embodiments, the UE 200 may include a first SIM interface (not shown) that may receive a first SIM (e.g., SIM A 206), which may be associated with one or more RATs. In addition, the UE 200 may also include a second SIM interface (not shown) that may receive a second SIM (e.g., SIM B 207), which may be associated with one or more RATs that may be different (or the same in some cases) than the one or more RATs associated with SIM A 206. Each SIM may enable a plurality of RATs by being configured as a multi-mode SIM, as described herein. In some embodiments, a first RAT enabled may be a same or different RAT as a second RAT (e.g., a DSDS device may enable two RATs), where both of them may be GSM, or one of them may be GSM and the other may be W-CDMA. In addition, two RATs (which may be the same or different) may each be associated with a separate subscription, or both of them may be associated with a same subscription. For example, a DSDS device may enable LTE and GSM, where both of the RATs enabled may be associated with a same subscription, or, in other cases, LTE may be associated with a first subscription and GSM may be associated with a second subscription different from the first subscription.

In embodiments in which the UE 200 comprises a smart phone, or the like, the UE 200 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various RATs. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware (UE 200) specifically configured for performing operations described herein. Hardware and/or software for the functions may be incorporated in the UE 200 during manufacturing, for example, as part of the original equipment manufacturer's (“OEM's”) configuration of the UE 200. In further embodiments, such hardware and/or software may be added to the UE 200, after manufacturing of the UE 200, such as by, but not limited to, installing one or more software applications onto the UE 200.

In some embodiments, the UE 200 may include, among other things, additional SIM(s), SIM interface(s), additional RF resource(s) (i.e., sets of RF resources) associated with the additional SIM(s), and additional antennae for connecting to additional RATs supported by the additional SIMs.

Embodiments may be implemented in a UE that performs tune-away or other similar procedures to support communication with multiple RATs. In particular, embodiments may be implemented in a UE capable of concurrently communicating with more than one RAT on a single RF chain, (i.e., a single receiver/transmitter module). For example, a UE may be configured to communicate with both the AT&T W-CDMA network and the Verizon CDMA2000 network.

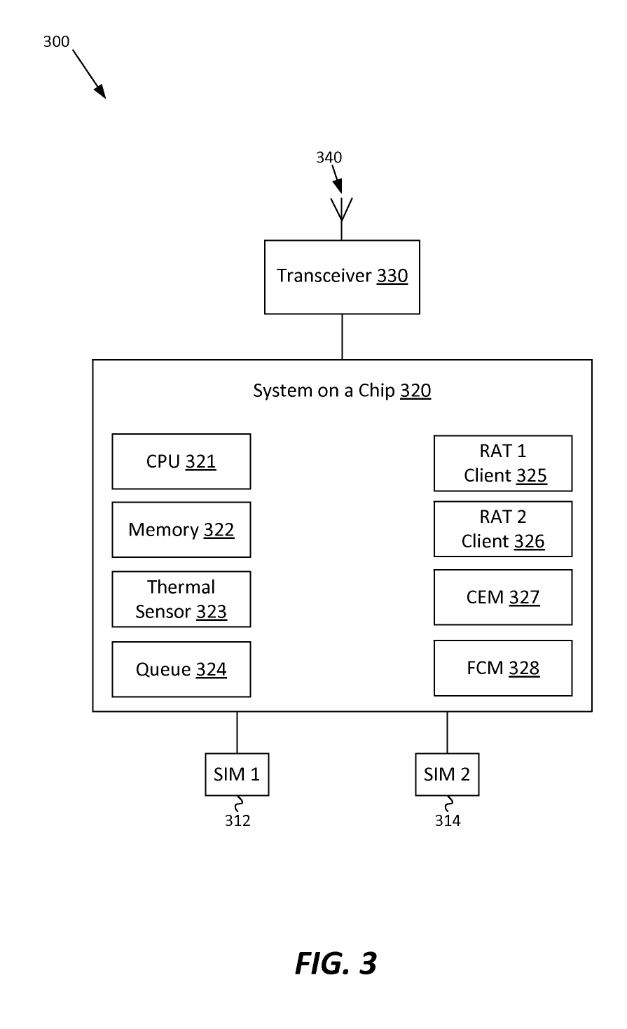

FIG. 3 is a schematic diagram illustrating an example of a UE 300 according to various embodiments. With reference to FIGS. 1-3, the UE 300 may correspond to the UE 110, 200. According to some embodiments, the UE 300 may include: SIM 1 312, SIM 2 314, system on a chip 320, CPU 321, memory 322, thermal sensor 323, queue 324, RAT 1 client 325, RAT 2 client 326, client error monitor (“CEM”) 327, flow control manager (“FCM”) 328, transceiver 330, and antenna 340.

In some embodiments, the SIM 1 312 and the SIM 2 314 may be subscriber identity modules that provide subscriptions for multiple RATs. The SIM 1 312 and the SIM 2 314 may be provided similar to the SIM A 206 and the SIM B 207.

In some embodiments, the system on a chip 320 may include various components used for the operation of the UE 300, such as a processor, memory, and some RF resources. The system on a chip 320 may be provided as a combination of the processor 201, the memory 202, and portions of the RF resources 204. With respect to RF resources, the system on a chip 320 may be configured to contain components related to a modem functionality but not components related to transceiver functionality. For example, the system on a chip 320 may contain modulation and demodulation components. The system on a chip 320 may be coupled to the transceiver 330.

According to some embodiments, the system on a chip 320 may include the CPU 321, the memory 322, and the thermal sensor 323. The CPU 321 may be a processor (e.g., the processor 201, the baseband processor 205, or the like) of the UE 300. The memory 322 may be a storage device (e.g., the memory 202) of the UE 300. The thermal sensor 323 may be a sensor configured to detect a thermal value (e.g., temperature) adjacent to the thermal sensor 323 inside the UE 300. In some embodiments, the flow control manager 328 may be configured to receive values indicating a state of the CPU 321, the memory 322, and/or the thermal sensor 323. For example, the flow control manager 328 may receive a value indicating the percentage of computing capacity of the CPU 321 that is currently being utilized (e.g., 85%). As another example, the flow control manager 328 may be configured to receive a value indicating the percentage of storage capacity of the memory 322 that is currently being utilized (e.g., 90%). As another example, the flow control manager 328 may be configured to receive a value indicating the thermal value detected by the thermal sensor 323 (e.g., 90 degrees Fahrenheit). In various embodiments, the flow control manager 328 may be configured to receive some or all of the condition values for the CPU 321, the memory 322, and the thermal sensor 323.

According to some embodiments, the system on a chip 320 may include the queue 324. The queue 324 may be a queue for holding data prior to transmission for one or more radio access technologies. In some embodiments, the queue 324 may hold data waiting for transmission using the transceiver 330 and the antenna 340. The queue 324 may hold data for more than on radio access technology (e.g., RAT 1 and RAT 2). In some embodiments, the flow control manager 328 may be configured to receive values indicating the volume of data presently stored in the queue 324 for each of the radio access technologies supported by the UE 300 (e.g., RAT 1 with 250 KB, RAT 2 with 50 MB). In some embodiments, the transceiver 330 may have the queue 324. In some embodiments, the system on a chip 320 and the transceiver 330 may each have a queue according to the queue 324. The queue 324 may be implemented using hardware and/or software. Other configurations of the queue 324 are possible according to various embodiments.

According to some embodiments, the system on a chip 320 may include the RAT 1 client 325 and the RAT 2 client 326. Each of the RAT 1 client 325 and the RAT 2 client 326 may be a client module for a radio access technology. For example, the RAT 1 client 325 may be a GSM layer 1 module, while the RAT 2 client 326 may be a LTE layer 1 module. According to some embodiments, the flow control manager 328 may be configured to transmit flow control commands to the RAT 1 client 325 and the RAT 2 client 326. For example, the flow control manager 328 may be configured to transmit flow control down and flow control off commands to each of the RAT 1 client 325 and the RAT 2 client 326. According to some embodiments, the RAT 1 client 325 and the RAT 2 client 326 may be configured to transmit information to the client error monitor 327. For example, the RAT 1 client 325 and the RAT 2 client 326 may be configured to transmit values for channel quality metrics to the client error monitor 327. The RAT 1 client 325 and the RAT 2 client 326 may be configured to transmit additional values of information to the client error monitor 327 according to some embodiments. The RAT 1 client 325 and the RAT 2 client 326 may be implemented using hardware and/or software. In some embodiments, the system on a chip 320 may include additional RAT client modules (e.g., a RAT 3 client module). Other configurations of the RAT 1 client 325 and the RAT 2 client 326 are possible according to various embodiments.

According to some embodiments, the system on a chip 320 may include the client error monitor 327. The client error monitor 327 may be a module configured to transmit information to the flow control manager 328. For example, the client error monitor 327 may transmit values for channel quality metrics (e.g., as previously received from the RAT 1 client 325 and the RAT 2 client 326) to the flow control manager 328. The client error monitor 327 may be configured to transmit additional values of information to the flow control manager 328 according to some embodiments. The client error monitor 327 may be implemented using hardware and/or software. Other configurations of the client error monitor 327 are possible according to various embodiments.

According to some embodiments, the system on a chip 320 may include the flow control manager 328. The flow control manager 328 may be a module configured to manage the application of flow control to the radio access technologies supported by the UE 300. In some embodiments, the flow control manager 328 may determine when a flow control condition is met. This determination may be made based on information received from the CPU 321, the memory 322, and/or the thermal sensor 323. In some embodiments, the flow control manager 328 may select a subset of all radio access technologies supported by the UE 300 for application of flow control. For example, the flow control manager 328 may determine which radio access technologies should have flow control applied based on information received from the queue 324, the client error monitor 327, the RAT 1 client 325, and/or the RAT 2 client 326. After having selected a subset of radio access technologies for the application of flow control, the flow control manager 328 may transmit a flow control command (e.g., flow control down command) to each radio access technology in the selected subset. The flow control manager 328 may additionally transmit a flow control command (e.g., flow control off command) to a radio access technology that is already applying flow control when the flow control manger 328 determines that a flow control condition has improved. The flow control manager 328 may be implemented using hardware and/or software. Other configurations of the flow control manager 328 are possible according to various embodiments.

In some embodiments, one or more of the CPU 321, the memory 322, the thermal sensor 323, the queue 324, the RAT 1 client 325, the RAT 2 client 326, the client error monitor 327, and the flow control manager 328 may be provided separate of the system on a chip 320. For example, in some embodiments the thermal sensor 323 may be provided as a component of the UE 300 but separate from the system on a chip 320.

In some embodiments, the transceiver 330 may include one or more transmitters and one or more receivers configured to support communication using multiple RATs. The transceiver 330 may support active communication on a first RAT (e.g., RAT 1), while simultaneously supporting simultaneous mode communication for a second RAT (e.g., RAT 2). In some embodiments, the transceiver 330 may support communication on more than two RATs. The transceiver 330 may use the antenna 340 to send and receive electromagnetic signals for the various RATs supported by the UE 300. Other configurations of the transceiver 330 are possible in various embodiments.

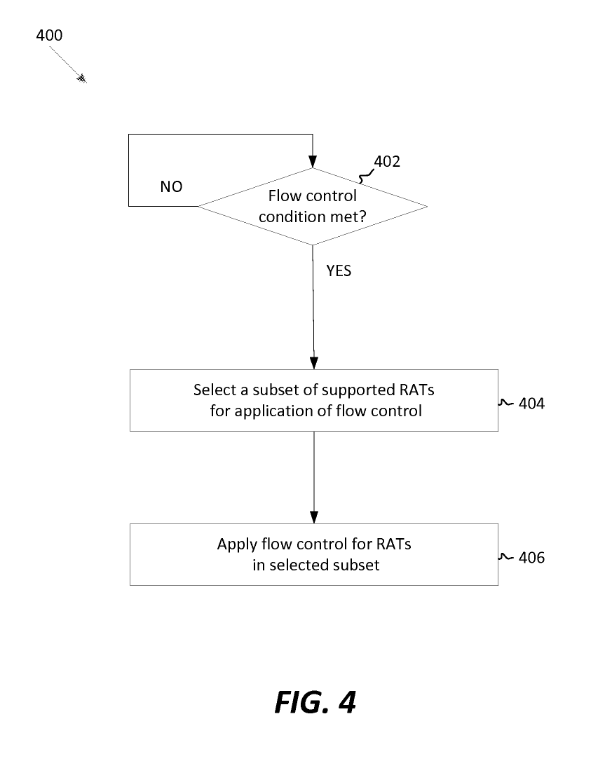

FIG. 4 is a flowchart of a process 400 according to various embodiments. With reference to FIGS. 1-4, the process 400 may be performed by a UE (e.g., the UEs 110, 200, 300).

At block 402, a determination is made as to whether a flow control condition is met. The block 402 may include a UE (e.g., the UE 300) determining whether a hardware component of the UE (e.g., the CPU 321, the memory 322) or the UE itself has reached a predefined state. For example, the block 402 may include the UE determining whether a processor of the UE (e.g., the CPU 321) has exceeded a particular level of usage of overall capacity (e.g., greater than 95% utilization). As another example, the block 402 may include the UE determining whether a storage device of the UE (e.g., the memory 322) has exceeded a particular level of usage of overall capacity (e.g., greater than 90% of storage capacity used). As another example, the block 402 may include the UE determining whether the UE has exceeded a particular thermal level (e.g., as detected by the thermal sensor 323) (e.g., greater than 90 degrees Fahrenheit). In some embodiments, the flow control condition of the block 402 may be based on a parameter of the UE itself. This may be in contrast to the state of some entity external to the UE itself (e.g., a network to which the UE is connected). For example, the flow control condition of the block 402 may be a condition of a hardware or software component of the UE, as opposed to a level of throughput or state of congestion in a network to which the UE is connected.

If the flow control condition is determined to be met at the block 402 (block 402: Yes), then the process 400 continues at block 404. If the flow control condition is determined to not be met at the block 402 (block 402: No), then the process 400 continues at the block 402. In the latter case, the process 400 may essentially wait in a state of performing the block 402 until a flow control condition is determined to be met. In some embodiments, when a flow control condition is determined to not be met at the block 402, the UE may wait a period of time (e.g., two seconds) before again performing the determination of the block 402.

At block 404, a subset of all RATs supported by the UE is selected for application of flow control. The block 404 may be performed in response to determining that a flow control condition has been met at the block 402. The block 404 may include the UE selecting a proper subset of all supported radio access technologies for application of flow control. For example, if the UE supports RAT 1, RAT 2, and RAT 3, then the block 404 may include selecting a subset containing only RAT 1 for the application of flow control. As another example, if the UE supports RAT 1, RAT 2, and RAT 3, then the block 404 may include selecting a subset containing RAT 1 and RAT 3 for the application of flow control. In some embodiments, the subset of radio access technologies selected at block 404 may not include all radio access technologies supported by the UE.

The block 404 may include selecting the subset of radio access technologies based on various criteria. In some embodiments, the block 404 may include selecting the subset of radio access technologies based on base station loading levels for each of the supported radio access technologies. For example, the UE may select the subset of radio access technologies as those radio access technologies with a lowest ratio of actual throughput to requested throughput. In some embodiments, the block 404 may include selecting the subset of radio access technologies based on the volume of data in a queue (e.g., the queue 324) for each of the supported radio access technologies. For example, the UE may select the subset of radio access technologies as those radio access technologies with a highest volume of data in a transmit queue of the UE. In some embodiments, the block 404 may include selecting the subset of radio access technologies based on channel quality metrics for each of the supported radio access technologies. For example, the UE may select the subset of radio access technologies as those radio access technologies with poorest values for one or more channel quality metrics as compared to the other supported radio access technologies.

At block 406, flow control is applied for the radio access technologies in the subset selected at the block 404. The block 406 may include the UE changing the data rate used for each radio access technology in the selected subset (i.e., as selected at the block 404) from a presently used data rate value to some other data rate value. The block 406 may include the UE changing the data rate used for each radio access technology in the selected subset (i.e., as selected at the block 404) from a presently used data rate to a lower data rate. In some embodiments, each radio access technology in the selected subset (i.e., as selected at the block 404) may generally determine its own data rate independently of the other radio access technologies, based on various factors (e.g., supported data rates, network congestion, channel quality). In such embodiments, the block 406 may include each radio access technology in the selected subset (i.e., as selected at the block 404) changing the data rate used to a lower data rate, but still doing so independently of the other radio access technologies.

The process 400, as described, departs from conventional techniques at least inasmuch as flow control is selectively applied to fewer than all radio access technologies supported by the UE. The conventional approach of applying flow control to all supported radio access technologies may result in inefficient throttling of data rates in a coarse fashion. Contrary to the conventional approach, the process 400 may allow targeted application of flow control to only some supported radio access technologies based on criteria designed to improve overall throughput of the device and specific throughputs of some of the supported radio access technologies. The process 400 may additionally be advantageous as the process 400 may not require coordination between the UE and any base station or network with which the UE is in communication. In particular, the process 400 may be performed transparently to the various networks and base station with which the supported radio access technologies of the UE communicate.

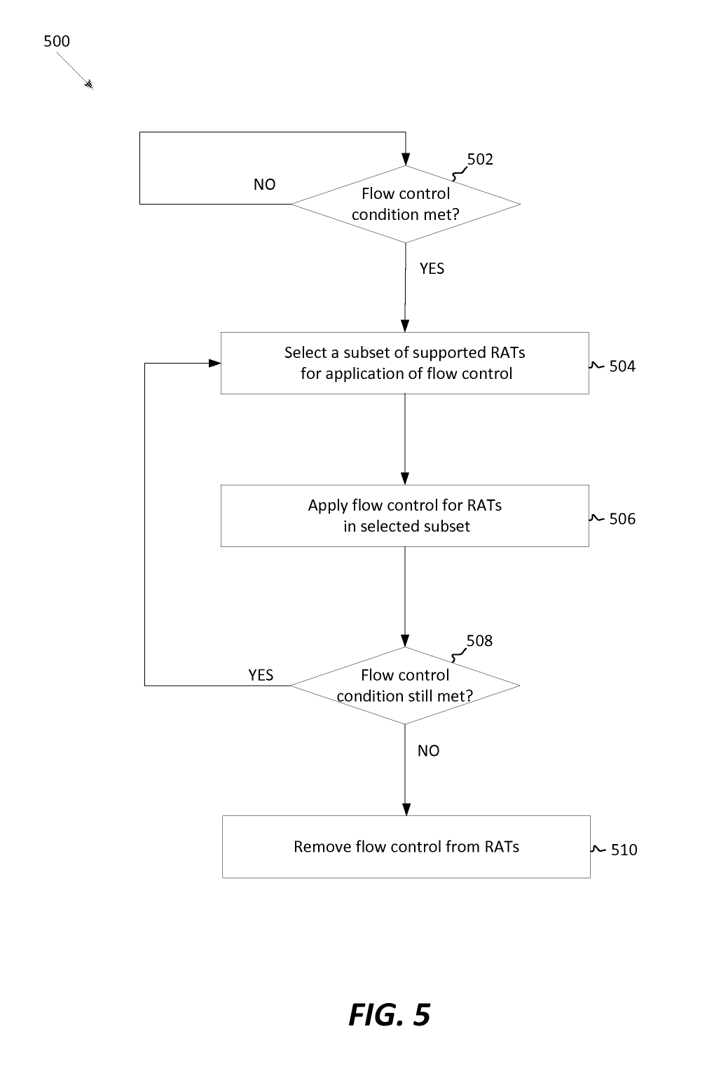

FIG. 5 is a flowchart of a process 500 according to various embodiments. With reference to FIGS. 1-5, the process 500 may be performed by a UE (e.g., the UEs 110, 200, 300).

At block 502, a determination is made as to whether a flow control condition has been met. The block 502 may include a UE (e.g., the UE 300) determining whether a hardware component of the UE (e.g., the CPU 321, the memory 322) or the UE itself has reached a predefined state. In some embodiments, the block 502 may be performed substantially as described with respect to the block 402 of the process 400. If the flow control condition is determined to be met at the block 502 (block 502: Yes), then the process 500 continues at block 504. If the flow control condition is determined to not be met at the block 502 (block 502: No), then the process 500 continues at the block 502. In the latter case, the process 500 may essentially wait in a state of performing the block 502 until a flow control condition is determined to be met. In some embodiments, when a flow control condition is determined to not be met at the block 502, the UE may wait a period of time (e.g., two seconds) before again performing the determination of the block 502.

At block 504, a subset of all RATs supported by the UE is selected for application of flow control. The block 504 may be performed in response to determining that a flow control condition has been met at the block 502. The block 504 may include the UE selecting a subset of all supported radio access technologies for application of flow control. In some embodiments, the subset selected at block 504 may be selected based on various criteria as described with respect to the block 404 of the process 400.

At block 506, flow control is applied for the radio access technologies in the subset selected at the block 504. The block 506 may include the UE changing the data rate used for each radio access technology in the selected subset (i.e., as selected at the block 504) from a presently used data rate value to some other data rate value. In some embodiments, the flow control may be applied at the block 506 substantially as described with respect to the block 406 of the process 400.

At block 508, a determination is made as to whether the flow control condition is still met. The block 508 may include determining whether the flow control condition previously determined to be met at the block 502 now remains met even after the application of flow control at the block 506. If the flow control condition remains met (block 508: Yes), then the process 500 returns to the block 504. If the flow control condition is no longer met (block 508: No), then the process 500 continues at block 510.

In some embodiments, the process 500 may return to the block 504 after having already performed the blocks 504, 506, and 508 based on an affirmative determination that a flow control condition is still met at the block 508. In such cases, the process 500 may include at least one additional iteration of the blocks 504, 506, and 508. In subsequent iterations of the block 504, the UE may select a subset of all supported radio access technologies as previously described with respect to the block 504. However, in subsequent iterations of the block 504, the UE may refrain from again selecting a radio access technology that was already selected as part of a subset in a previous iteration of the block 504. Such previously selected radio access technologies may have already been subjected to flow control, so it may be preferable to not apply further flow control to the previously selected radio access technologies. However, in other embodiments, it may be acceptable to again select a previously selected radio access technology. In such cases, a radio access technology selected for a second or more times with an iteration of the block 504 may be the subject of further flow control application in subsequent performance of the block 506.

In instances wherein the process 500 involves a second or further iteration of the block 504, the application of flow control to the selected subset at the block 506 may only include application of flow control to the radio access technologies included in the subset selected as part of the second or further iteration of the block 504. For example, if a first iteration of the block 504 includes selection of only a RAT 1 as part of the subset, then the first iteration of the block 506 may include only application of flow control to the RAT 1. If a second iteration of the block 504 (based on a determination of Yes at a first iteration of the block 508), includes selection of only a RAT 2 as part of the subset, then the second iteration of the block 506 may include only application of flow control to the RAT 2. In such a case, the flow control previously applied to the RAT 1 (i.e., as part of the first iteration of the block 506) may remain in place, but no further flow control may be applied to the RAT 1 as part of the second iteration of the block 506.

At the block 510, flow control is removed from radio access technologies. The block 510 may include removing flow control from all radio access technologies to which flow control was applied as part of any iteration of the block 506.

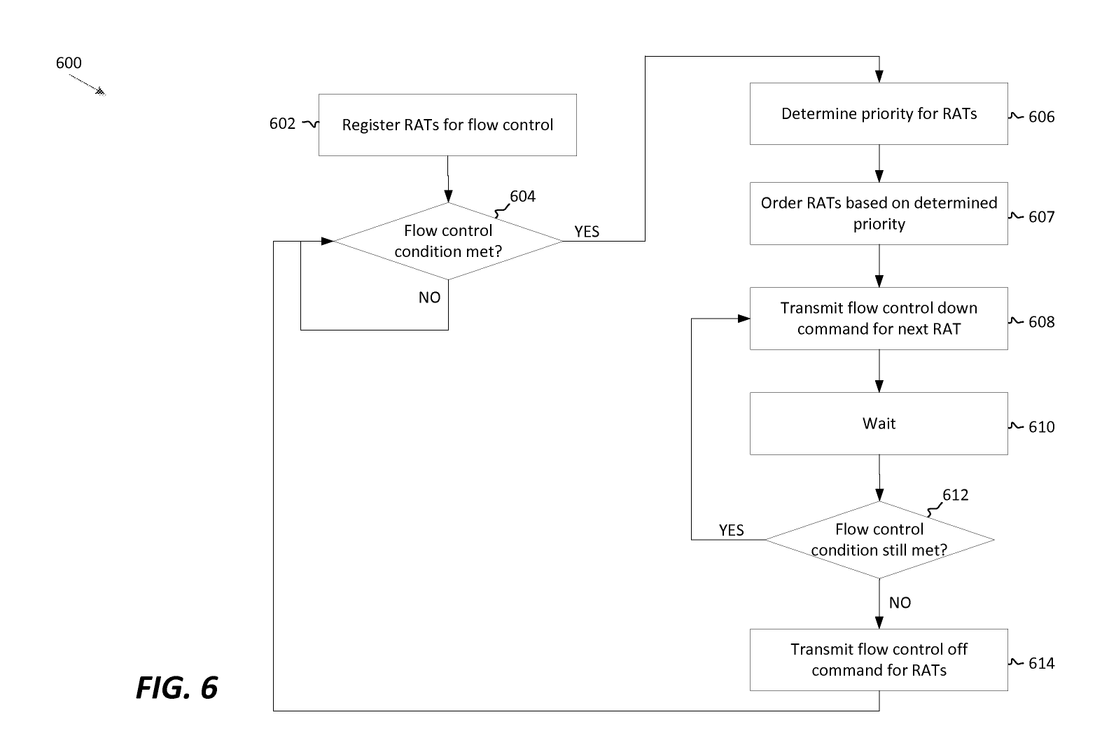

FIG. 6 is a flowchart of a process 600 according to various embodiments. With reference to FIGS. 1-6, the process 600 may be performed by a UE (e.g., the UEs 110, 200, 300).

At block 602, radio access technologies are registered for flow control. The block 602 may include multiple radio access technology modules (e.g., the RAT 1 client 325, the RAT 2 client 326, etc.) registering with a flow control module (e.g., the flow control manager 328). In some embodiments, registration of a radio access technology for flow control may allow a UE (e.g., the UE 300) to apply flow control to that radio access technology. According to some embodiments, the block 602 may be omitted. For example, the process 600 may be performed without requiring a distinct registration of radio access technologies. As another example, the radio access technologies supported by the UE may be pre-registered upon initial operation of the UE.

At block 604, a determination is made as to whether a flow control condition has been met. The block 604 may include a UE (e.g., the UE 300) determining whether a hardware component of the UE (e.g., the CPU 321, the memory 322, etc.) or the UE itself has reached a predefined state. In some embodiments, the block 604 may be performed similarly as described with respect to the block 402 of the process 400. If the flow control condition is determined to be met at the block 604 (block 604: Yes), then the process 600 continues at block 606. If the flow control condition is determined to not be met at the block 604 (block 604: No), then the process 600 continues at the block 604. In the latter case, the process 600 may essentially wait in a state of performing the block 604 until a flow control condition is determined to be met. In some embodiments, when a flow control condition is determined to not be met at the block 604, the UE may wait a period of time (e.g., two seconds) before again performing the determination of the block 604.

At the block 606, priority is determined for the radio access technologies. The block 606 may include a UE generating a priority value for all supported radio access technologies. In some embodiments, the UE may determine priority values for each of the supported radio access technologies based on base station loading levels for each of the supported radio access technologies. In some embodiments, the UE may determine priority values for each of the supported radio access technologies based on the volume of data in a queue (e.g., the queue 324) for each of the supported radio access technologies. In some embodiments, the UE may determine priority values for each of the supported radio access technologies based on channel quality metrics for each of the supported radio access technologies. In some embodiments, if only one radio access technology is registered for flow control (e.g., the block 602 was only performed for RAT 1), then the block 606 may include determining the order of the single radio access technology without further analysis or priority determination.

At the block 607, the radio access technologies are ordered based on the priority determination. In some embodiments, the block 608 may include the UE ordering all supported radio access technologies based on the priority values determined at the block 606. In some embodiments, the block 607 may include ordering the radio access technologies in ascending order from a radio access technology with a lowest priority value to a radio access technology with a highest priority value.

At block 608, a flow control down command is transmitted for a radio access technology. The block 608 may include a flow control module (e.g., the flow control manager 328) transmitting a flow control down command to a radio access technology module based on the order determined at the block 607. In particular, the flow control module may transmit a flow control down command to the first radio access technology module in the order (i.e., the lowest priority) when the block 608 is first performed. In any subsequent iterations of the block 608, the flow control module may transmit a flow control down command to subsequent radio access technology modules in the order (e.g., the second lowest priority radio access technology in the second iteration of the block 608). The flow control down command may be a command that instructs a radio access technology module (e.g., the RAT 1 client 325) receiving the flow control down command to reduce the data rate used by that radio access technology.

At block 610, waiting is performed. The block 610 may include the UE waiting a period of time (e.g., two seconds or other suitable amount of time) after transmission of the flow control down command at the block 608. The block 610 may be effective to allow the radio access technology module receiving the flow control down command (i.e., as transmitted at the block 608) to reduce the data rate used by that radio access technology. In addition, the block 610 may be effective to allow the flow control condition (i.e., as determined to be met at the block 604) to improve based on the data rate reduction resulting from the performance of the block 608. At least in this way, the waiting of the block 610 may be performed in order to allow a sufficient period of time for the flow control condition to improve after having applied some flow control and prior to taking further action.

At block 612, a determination is made as to whether the flow control condition is still met. The block 612 may include determining whether the flow control condition previously determined to be met at the block 604 is still met even after the application of flow control resulting from the transmission of the flow control down command at the block 608. If the flow control condition remains met (block 612: Yes), then the process 600 returns to the block 608. If the flow control condition is no longer met (block 612: No), then the process 600 continues at block 614.

At the block 614, a flow control off command is transmitted for the radio access technologies. The block 614 may include a flow control module (e.g., the flow control manager 328) transmitting a flow control off command to one or more radio access technology modules (e.g., the RAT 1 client 325, the RAT 2 client 326). In particular, the block 614 may include a flow control module transmitting a flow control off command to all radio access technology modules that previously received a flow control down command as transmitted at an iteration of the block 608. The flow control off command may be a command that instructs a radio access technology module (e.g., the RAT 1 client 325) receiving the flow control off command to no longer reduce or otherwise restrict the data rate used by that radio access technology (at least with respect to flow control purposes).

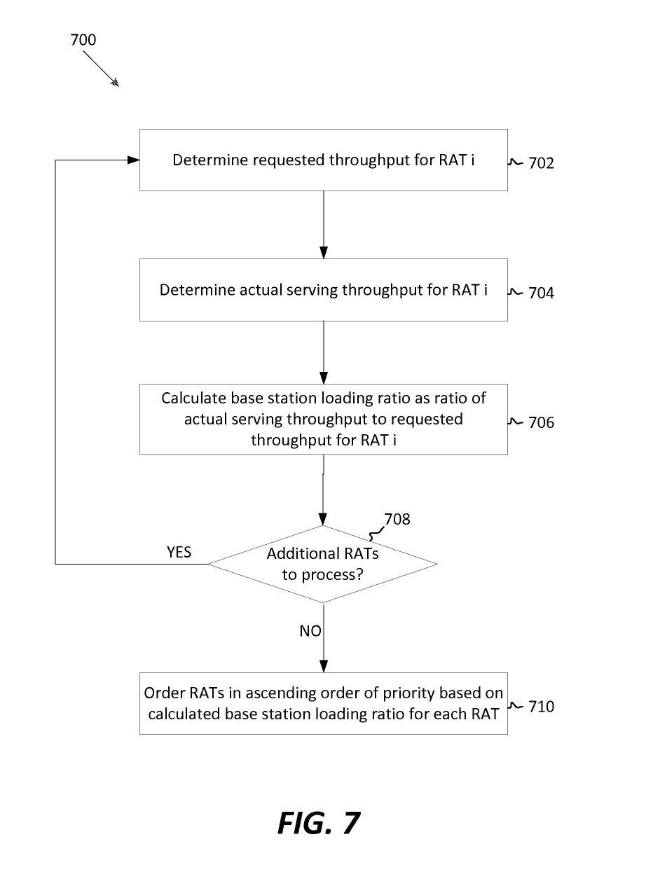

FIG. 7 is a flowchart of a process 700 according to various embodiments. With reference to FIGS. 1-7, the process 700 may be performed by a UE (e.g., the UEs 110, 200, 300). According to some embodiments, the process 700 may be performed so as to determine priority values for radio access technologies as part of performance of the block 606 of the process 600 and so as to order radio access technologies as part of performance of the block 607 of the process 600. For example, the blocks 702, 704, 706, and 708 may be performed to determine priority values for radio access technologies as part of the block 606 of the process 600, and the block 710 may be performed to order radio access technologies as part of the block 607 of the process 600.

At the block 702, a requested throughput value is determined for a RAT i. RAT i may be any single RAT supported by the UE (e.g., the UE 300). The requested throughput value may be a level of throughput (e.g., 10 Mbps) requested by a radio access technology module (e.g., the RAT 1 client 325, the RAT 2 client 326) of the RAT i from a base station for the RAT i. As such, the requested throughput value may reflect a preferred level of throughput by the radio access technology module for the RAT i in the UE. In some embodiments, a flow control module (e.g., the flow control manager 328) may determine the requested throughput value based on requesting and/or receiving such information from a radio access technology module (e.g., the RAT 1 client 325) for the RAT i.

At the block 704, an actual serving throughput value is determine for the RAT i. The actual serving throughput value may be a level of throughput (e.g., 7 Mbps) presently being achieved by the radio access technology module for the RAT i. The actual serving throughput value may reflect a level of throughput granted by the base station for the RAT i to the radio access technology module for the RAT i. In some embodiments, the actual serving throughput value may be granted to the radio access technology module for the RAT i after the radio access technology module for the RAT i has already requested the requested throughput value (i.e., as determined at the block 702) from the base station for the RAT i. In some embodiments, a flow control module (e.g., the flow control manager 328) may determine the actual serving throughput value based on requesting and/or receiving such information from a radio access technology module (e.g., the RAT 1 client 325) for the RAT i.

At the block 706, a base station loading ratio is calculated for the RAT i. The base station loading ratio may be calculated as the ratio of the actual serving throughput for the RAT i (i.e., as determined at the block 704) to the requested throughput for the RAT i (i.e., as determined at the block 702) (e.g., 7 Mbps to 10 Mbps or 0.7). Because the actual serving throughput value for the RAT i may be granted by the base station for the RAT i after the radio access technology module for the RAT i has already requested the requested throughput value, the ratio of these two values may reflect the base station's ability to meet the requested throughput value while being limited by the load of other UE with which the base station is in communication. As such, it may be expected that a lower value for the base station loading ratio indicates a more heavily loaded base station, as the actual serving throughput value is a smaller portion of the requested throughput value. Conversely, it may be expected that a higher value for the base station loading ratio indicates a less heavily loaded base station.

At the block 708, a determination is made as to whether there are additional radio access technologies to process. The block 708 may include determining whether the RAT i was the final radio access technology registered for flow control in the UE. If additional radio access technologies remain to be processed (block 708: Yes), then the process 700 returns to the block 702 to process the additional radio access technologies. In such cases, the blocks 702, 704, and 706 may be performed for one or more additional radio access technologies. If no additional radio access technologies remain to be processed (block 708: No), then the process 700 continues at the block 710.

At the block 710, the radio access technologies are ordered in ascending order of priority based on the calculated base station loading ratio for each radio access technology. The block 710 may include ordering the radio access technologies from the lowest value for the base station loading ratio (i.e., the most heavily loaded base station) to the highest value for the base station loading ratio (i.e., the least heavily loaded base station). As such, the first radio access technology in the order may be the radio access technology with the most heavily loaded base station.

The process 700 may be modified from that just described in various embodiments. In some embodiments, the base station loading ratio may be calculated differently. For example, the base station loading ratio may be calculated as one minus the ratio of the actual serving throughput to the requested throughput. In such cases, a lower value for the base station loading ratio would indicate a lower level of base station loading. As such, the ordering performed at the block 710 may be performed from highest base station loading ratio to lowest base station loading ratio so that the radio access technology with the most loaded base station remains as the first radio access technology in the order. The base station loading ratio may be calculated in other ways in various embodiments.

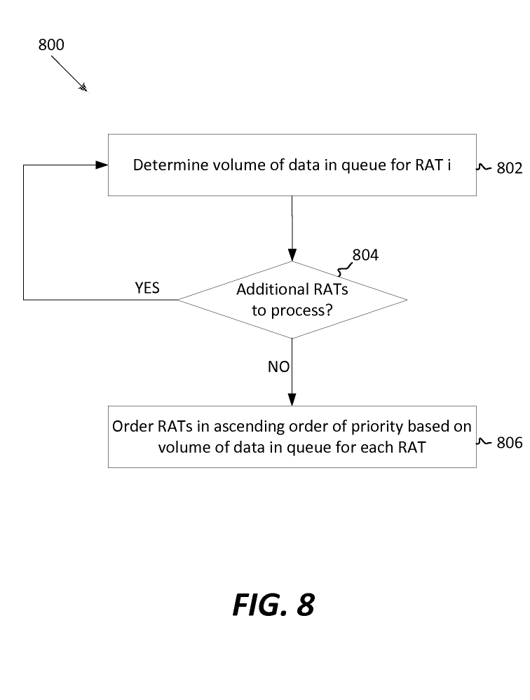

FIG. 8 is a flowchart of a process 800 according to various embodiments. With reference to FIGS. 1-8, the process 800 may be performed by a UE (e.g., the UEs 110, 200, 300). According to some embodiments, the process 800 may be performed so as to determine priority values for radio access technologies as part of performance of the block 606 of the process 600 and so as to order radio access technologies as part of performance of the block 607 of the process 600. For example, the blocks 802 and 804 may be performed to determine priority values for radio access technologies as part of the block 606 of the process 600, and the block 806 may be performed to order radio access technologies as part of the block 607 of the process 600.

At the block 802, a volume of data in a queue is determined for a RAT i. The block 802 may include a flow control module (e.g., the flow control manager 328) determining a volume of data (e.g., 50 MB) in a queue (e.g., the queue 324) for the RAT i. The volume of data may be a volume of data awaiting transmission for the RAT i by a transceiver (e.g., the transceiver 330). In some embodiments, the flow control module (e.g., the flow control manager 328) may determine the volume of data based on requesting and/or receiving such information from a radio access technology module (e.g., the RAT 1 client 325) for the RAT i, requesting and/or receiving such information from the queue (e.g., the queue 324), or requesting and/or receiving such information from some other component (e.g., the CPU 321, the transceiver 330).

At the block 804, a determination is made as to whether there are additional radio access technologies to process. The block 804 may include determining whether the RAT i was the final radio access technology registered for flow control in the UE. If additional radio access technologies remain to be processed (block 804: Yes), then the process 800 returns to the block 802 to process the additional radio access technologies. In such cases, the block 802 may be performed for one or more additional radio access technologies. If no additional radio access technologies remain to be processed (block 804: No), then the process 800 continues at the block 806.

At the block 806, the radio access technologies are ordered in ascending order of priority based on the volume of data in the queue for each radio access technology. The block 806 may include ordering the radio access technologies from the highest value for volume of data in the queue (i.e., the highest usage of the queue) to the lowest value for volume of data in the queue (i.e., the lowest usage of the queue). As such, the first radio access technology in the order may be the radio access technology with the most volume of data in the queue.

The ordering performed at the block 806 may be advantageous for various reasons. In some embodiments, this ordering may be advantageous as it may tend to cause data rate reduction on the radio access technologies with more data in the queue. In some cases, radio access technologies with large volumes of data in the queue may be causing a larger proportional use of resources in the UE (e.g., the CPU 221, the memory 222, thermal level as detected by the thermal sensor 223). As such, it may be appropriate to target such radio access technologies for data rate reduction, because such targeted data rate reduction may be expected to produce a larger effect on a flow control condition (e.g., CPU capacity utilization) than would data rate reduction for a radio access technology contributing a smaller proportional use of resources in the UE. In some embodiments, this ordering may be additionally advantageous as the ordering may target data radio access technologies for data rate reduction over voice radio access technologies. Data radio access technologies may be expected to produce larger volumes of data in the queue when those data radio access technologies are active than would a voice radio access technology (e.g., during a voice telephone call). Because data radio access technologies may be more tolerant to delays caused by reduction in data rate, it may thus be advantageous to bias towards application of flow control and reduction of data rate to data radio access technologies.

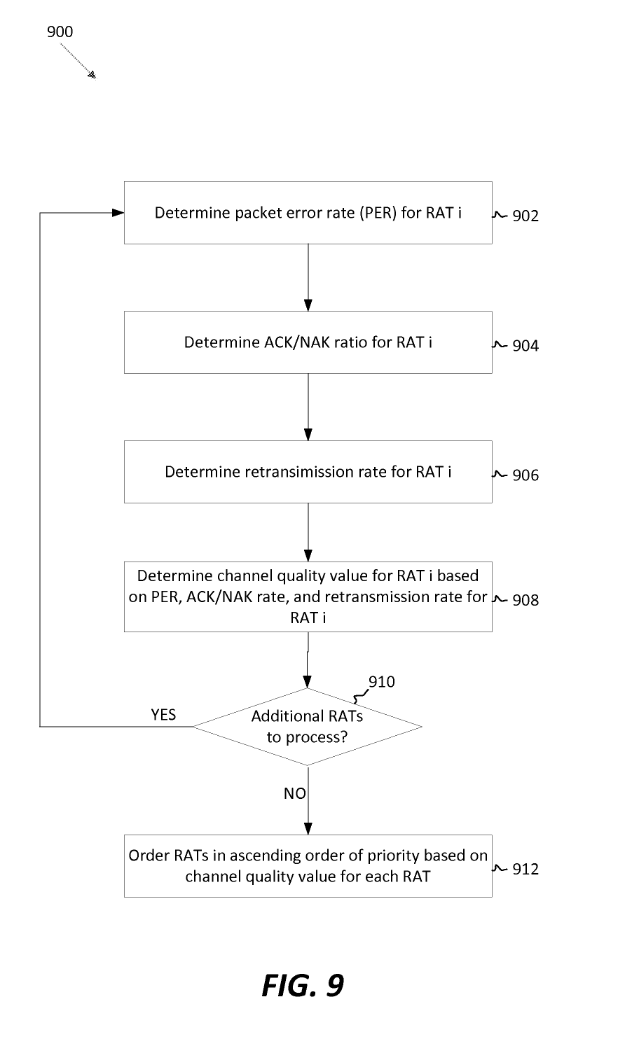

FIG. 9 is a flowchart of a process 900 according to various embodiments. With reference to FIGS. 1-9, the process 900 may be performed by a UE (e.g., the UEs 110, 200, 300). According to some embodiments, the process 900 may be performed so as to determine priority values for radio access technologies as part of performance of the block 606 of the process 600 and so as to order radio access technologies as part of performance of the block 607 of the process 600. For example, the blocks 902, 904, 906, 908, and 910 may be performed to determine priority values for radio access technologies as part of the block 606 of the process 600, and the block 912 may be performed to order radio access technologies as part of the block 607 of the process 600.

At the block 902, a packet error rate (“PER”) is determined for a RAT i. The packet error rate for the RAT i may be a percentage representing the portion of all packets received by the UE for the RAT i that was received in error (e.g., 5%). In particular, a packet may be considered to be received in error if the packet could not be successfully decoded or an error detection encoding indicated an error in the decoded packet data. The packet error rate may be calculated based on a predefined number of most recently received packets, based on a predefined most recent period of time, or based on some other group of packets received for the RAT i. The packet error rate may reflect the frequency with which packet data is lost due to interference or noise in the channel between the UE and the base station. In some embodiments, the packet error rate for the RAT i may be determined by a radio access technology module (e.g., the RAT 1 client 325, the RAT 2 client 326) for the RAT i. In some embodiments, the block 902 may include providing the packet error rate determined by the radio access technology module for the RAT i to a client error module (e.g., the client error monitor 327). In some embodiments, the block 902 may include providing the packet error rate for the RAT i from a client error module (e.g., the client error monitor 327) to a flow control module (e.g., the flow control module 328).

At the block 904, an ACK/NAK ratio is determined for a RAT i. The ACK/NAK ratio for the RAT i may be a ratio (1/19) representing the number of negative-acknowledgements sent or received for the RAT i to the number of acknowledgements sent or received for the RAT i. An acknowledgment (“ACK”) may be used by the UE or the base station to indicate to the other device that a particular packet was successfully received and decoded. A negative-acknowledgement (“NAK”) may be used by the UE or the base station to indicate to the other device that a particular packet was not successfully received and decoded. The ACK/NAK ratio may be calculated based on a predefined number of most recently received or transmitted packets, based on a predefined most recent period of time, or based on some other group of packets received or transmitted for the RAT i. The ACK/NAK ratio may reflect the frequency with which packet data is lost due to interference or noise in the channel between the UE and the base station. In some embodiments, the ACK/NAK ratio for the RAT i may be determined by a radio access technology module (e.g., the RAT 1 client 325, the RAT 2 client 326) for the RAT i. In some embodiments, the block 904 may include providing the ACK/NAK ratio determined by the radio access technology module for the RAT i to a client error module (e.g., the client error monitor 327). In some embodiments, the block 904 may include providing the ACK/NAK ratio for the RAT i from a client error module (e.g., the client error monitor 327) to a flow control module (e.g., the flow control module 328).

At the block 906, a retransmission rate is determined for a RAT i. The retransmission rate for the RAT i may be a percentage representing the portion of all packets transmitted by the UE for the RAT i that was subsequently retransmitted (e.g., 5%). In particular, a packet may be retransmitted by the UE if the base station indicates to the UE that the packet was not successfully received and decoded. The retransmission rate may be calculated based on a predefined number of most recently transmitted packets, based on a predefined most recent period of time, or based on some other group of packets transmitted for the RAT i. The retransmission rate may reflect the frequency with which packet data is lost due to interference or noise in the channel between the UE and the base station. In some embodiments, the retransmission rate for the RAT i may be determined by a radio access technology module (e.g., the RAT 1 client 325, the RAT 2 client 326) for the RAT i. In some embodiments, the block 906 may include providing the retransmission rate determined by the radio access technology module for the RAT i to a client error module (e.g., the client error monitor 327). In some embodiments, the block 906 may include providing the retransmission rate for the RAT i from a client error module (e.g., the client error monitor 327) to a flow control module (e.g., the flow control module 328).

At the block 908, a channel quality value is determined for the RAT i. The block 908 may include determining a channel quality value (e.g., poor, moderate, good) based on the channel quality metrics values determined for the RAT i at the blocks 902, 904, and 906. In some embodiments, the UE may determine the channel quality value based on predefined ranges of values for each channel quality metric. For example, packet error rates between 0% and 5% may be considered good, packet error rates between 5% and 10% may be considered moderate, and packet error rates between 10% and 100% may be considered poor. As another example, retransmission rates between 0% and 5% may be considered good, retransmission rates between 5% and 10% may be considered moderate, and retransmission rates between 10% and 100% may be considered poor. As another example, ACK/NAK ratios between 0 and 1/19 may be considered good, ACK/NAK ratios between 1/19 and 2/18 may be considered moderate, and ACK/NAK ratios between 2/18 and 1 may be considered poor. Based on these predefined ranges of values for each channel quality metric and the values determined for the channel quality metrics for the RAT i at the blocks 902, 904, and 906, the block 908 may include producing a composite channel quality value based on an average of these underlying channel quality metric values (e.g., packet error rate of 2% (good), retransmission rate of 3% (good), and ACK/NAK ratio of 3/17 (moderate) results in “good” channel quality value). The channel quality value determined at the block 908 may be determined in other ways in various embodiments.

At the block 910, a determination is made as to whether there are additional radio access technologies to process. The block 910 may include determining whether the RAT i was the final radio access technology registered for flow control in the UE. If additional radio access technologies remain to be processed (block 910: Yes), then the process 900 returns to the block 902 to process the additional radio access technologies. In such cases, the blocks 902, 904, 906, and 908 may be performed for one or more additional radio access technologies. If no additional radio access technologies remain to be processed (block 910: No), then the process 900 continues at the block 912.

At the block 912, the radio access technologies are ordered in ascending order of priority based on the channel quality value for each radio access technology. The block 912 may include ordering the radio access technologies from the poorest value for the channel quality value (e.g., “poor”) to the best value for the channel quality value (e.g., “good”). As such, the first radio access technology in the order may be the radio access technology with the poorest channel quality value.

The ordering performed at the block 912 may be advantageous for various reasons. In some embodiments, this ordering may be advantageous as it may tend to cause data rate reduction on the radio access technologies with poorer channel qualities. It may be expected that radio access technologies with poorer channel qualities will make less efficient use of the available resources in the UE (e.g., the CPU 321, the memory 322, thermal level as detected by the thermal sensor 323), at least because a larger portion of the activity performed by such radio access technologies will be dedicated to retransmitting packets lost in the communication channel between the UE and the base station. Therefore, it may be advantageous to target radio such radio access technologies for data rate reduction, because the whole of all the supported radio access technologies in the UE may achieve a greater composite throughput for the same usage of resources in the UE. In some embodiments, this ordering may be additionally advantageous as the ordering may avoid targeting radio access technologies for data rate reduction that have a good channel quality and high throughput. Radio access technologies with good channel quality may be expected to achieve higher data throughput than radio access technologies with poorer channel quality. As such, activity taking place using the radio access technologies with good channel quality may be able to continue unimpaired if such radio access technologies are not targeted for data rate reduction. This may improve the user experience as at least those activities may not be adversely impacted by the application of flow control.

The process 900 may be modified from that just described in various embodiments. For example, while the process 900 has been described as using three different channel quality metrics (i.e., packet error rate, ACK/NAK ratio, and retransmission rate), different channel quality metrics and different numbers of channel quality metrics may be used in various embodiments. For example, in some embodiments, a packet error rate alone, an ACK/NAK ratio alone, or a retransmission rate alone may be used to determine the channel quality value at the block 908. In addition, the use of packet error rate, ACK/NAK ratio, and retransmission rate have been provided as examples, but other channel quality metrics may be used in various embodiments. The channel quality value may be calculated in other ways in various embodiments.

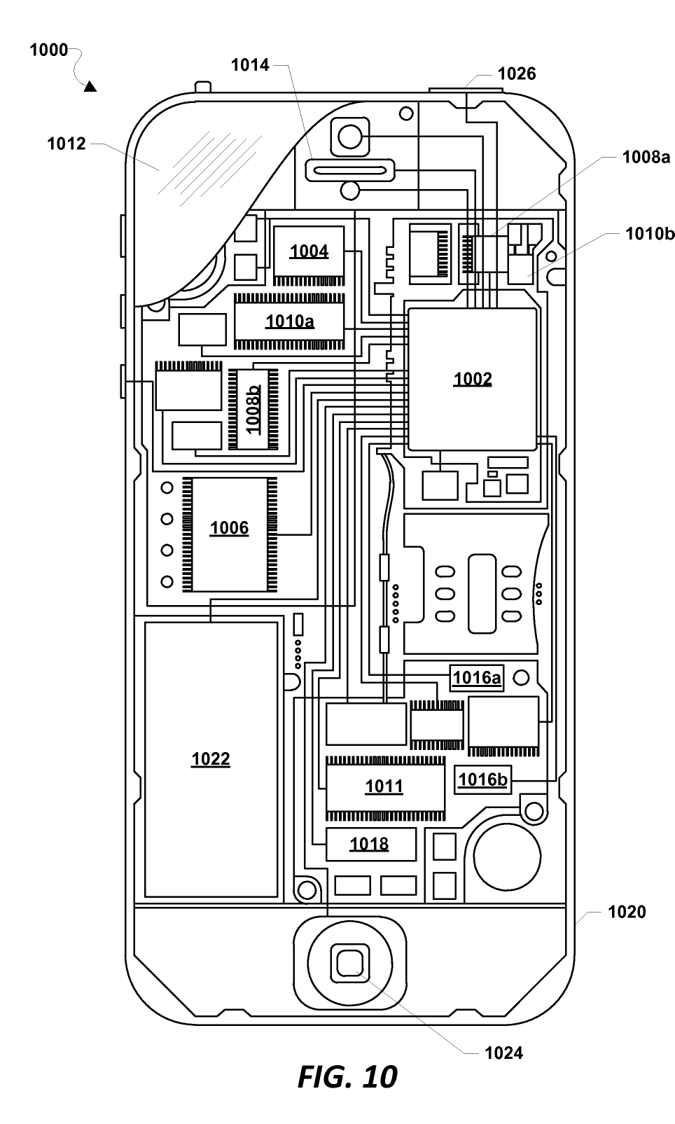

FIG. 10 illustrates an example of a UE 1000, which may correspond to the UEs 110, 200, 300 in FIGS. 1-3. With reference to FIGS. 1-10, the UE 1000 may include a processor 1002 coupled to a touchscreen controller 1004 and an internal memory 1006. The processor 1002 may correspond to the processor 201. The processor 1002 may be one or more multi-core integrated circuits designated for general or specific processing tasks. The internal memory 1006 may correspond to the memory 202. The memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the UE 1000 need not have touch screen capability. The touch screen controller 1004, the touchscreen panel 1012 may correspond to the user interface 203.

The UE 1000 may have one or more cellular network transceivers 1008a, 1008b coupled to the processor 1002 and to two or more antennae 1010 and configured for sending and receiving cellular communications. The transceivers 1008 and antennae 1010a, 1010b may be used with the above-mentioned circuitry to implement the various embodiment methods. The UE 1000 may include two or more SIM cards 1016a, 1016b, corresponding to SIM A 206 and SIM B 207, coupled to the transceivers 1008a, 1008b and/or the processor 1002 and configured as described above. The UE 1000 may include a cellular network wireless modem chip 1011 that enables communication via a cellular network and is coupled to the processor. The one or more cellular network transceivers 1008a, 1008b, the cellular network wireless modem chip 1011, and the two or more antennae 1010 may correspond to the RF resources 204.

The UE 1000 may include a peripheral device connection interface 1018 coupled to the processor 1002. The peripheral device connection interface 1018 may be singularly configured to accept one type of connection, or multiply configured to accept various types of physical and communication connections, common or proprietary, such as USB, FireWire, Thunderbolt, or PCIe. The peripheral device connection interface 1018 may also be coupled to a similarly configured peripheral device connection port (not shown).

The UE 1000 may also include speakers 1014 for providing audio outputs. The UE 1000 may also include a housing 1020, constructed of a plastic, metal, or a combination of materials, for containing all or some of the components discussed herein. The UE 1000 may include a power source 1022 coupled to the processor 1002, such as a disposable or rechargeable battery. The rechargeable battery may also be coupled to a peripheral device connection port (not shown) to receive a charging current from a source external to the UE 1000. The UE 1000 may also include a physical button 1024 for receiving user inputs. The UE 1000 may also include a power button 1026 for turning the UE 1000 on and off.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, and circuits have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some blocks or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to some embodiments without departing from the spirit or scope of the disclosure. Thus, the present disclosure is not intended to be limited to the embodiments shown herein but is to be accorded the widest scope consistent with the following claims and the principles and novel features disclosed herein.

What is claimed is:

1. A method for performing selective flow control in a user equipment supporting a plurality of radio access technologies, the method comprising:
determining whether a flow control condition is met;
selecting a subset of the plurality of radio access technologies, in response to determining that the flow control condition is met; and
applying flow control to the radio access technologies of the selected subset.

2. The method of claim 1,
wherein the subset of the plurality of radio access technologies does not include all the radio access technologies of the plurality of radio access technologies.

3. The method of claim 1,
wherein applying flow control to the radio access technologies of the selected subset comprises changing a data rate used for the radio access technologies of the selected subset.

4. The method of claim 1,
wherein the flow control condition is based on a state of a hardware component of the user equipment.

5. The method of claim 1,
wherein the flow control condition is not based on a throughput value for any one or more of the plurality of radio access technologies.

6. The method of claim 1,
wherein the flow control condition is based on a parameter of the user equipment.

7. The method of claim 6,
wherein the parameter of the user equipment is a usage capacity of a processor of the user equipment.

8. The method of claim 6,
wherein the parameter of the user equipment is a usage level of a memory device of the user equipment.

9. The method of claim 6,
wherein the parameter of the user equipment is a thermal value for the user equipment.

10. The method of claim 1,
wherein selecting the subset of the plurality of radio access technologies comprises selecting the subset based on a base station loading level for each of the plurality of radio access technologies.

11. The method of claim 10,
wherein selecting the subset based on a base station loading level for each of the plurality of radio access technologies comprises selecting a radio access technology from the plurality of radio access technologies that has a lowest value for a ratio of actual throughput to requested throughput.

12. The method of claim 1,
wherein selecting the subset of the plurality of radio access technologies comprises selecting the subset based on volume of data in a queue of the user equipment for each of the plurality of radio access technologies.

13. The method of claim 12,
wherein selecting the subset based on volume of data in a queue of the user equipment for each of the plurality of radio access technologies comprises selecting a radio access technology from the plurality of radio access technologies that has a highest volume of data in a transmit queue of the user equipment.

14. The method of claim 1,
wherein selecting the subset of the plurality of radio access technologies comprises selecting the subset based on one or more channel quality metrics for each of the plurality of radio access technologies.

15. The method of claim 14,
wherein selecting the subset based on one or more channel quality metrics for each of the plurality of radio access technologies comprises selecting a radio access technology from the plurality of radio access technologies that has poorest values for the one or more channel quality metrics as compared to values for the one or more channel quality metrics for the remaining radio access technologies of the plurality of radio access technologies.

16. The method of claim 14,
wherein the one or more channel quality metrics for each of the plurality of radio access technologies comprises a packet error rate for each of the plurality of radio access technologies.

17. The method of claim 14,
wherein the one or more channel quality metrics for each of the plurality of radio access technologies comprises an acknowledge (ACK)/negative-acknowledge (NAK) rate for each of the plurality of radio access technologies.

18. The method of claim 14,
wherein the one or more channel quality metrics for each of the plurality of radio access technologies comprises a retransmission rate for each of the plurality of radio access technologies.

19. The method of claim 1, further comprising:
registering each radio access technology of the plurality of radio access technologies for flow control.

20. The method of claim 1, further comprising:
transmitting a flow control down command,
wherein the flow control down command instructs the selected subset of radio access technologies to reduce a data rate.

21. The method of claim 1, further comprising:
transmitting a flow control off command,
wherein the flow control off command instructs the selected subset of radio access technologies to remove restrictions on a data rate.

22. The method of claim 1, further comprising:
determining whether the flow control condition is still met after said applying flow control to the radio access technologies of the selected subset.

23. The method of claim 22, further comprising:
selecting a second subset of the plurality of radio access technologies, in response to determining that the flow control condition is still met.

24. The method of claim 23, further comprising:
applying flow control to the radio access technologies of the selected second subset.

25. The method of claim 1,
wherein the determining whether a flow control condition is met is performed without coordination by a base station of any one or more of the plurality of radio access technologies.

26. A user equipment apparatus supporting a plurality of radio access technologies, the user equipment apparatus comprising:
one or more processors configured to:
determine whether a flow control condition is met;
select a subset of the plurality of radio access technologies, in response to determining that the flow control condition is met; and
apply flow control to the radio access technologies of the selected subset.

27. A user equipment apparatus supporting a plurality of radio access technologies, the user equipment apparatus comprising:
means for determining whether a flow control condition is met;
means for selecting a subset of the plurality of radio access technologies, in response to determining that the flow control condition is met; and
means for applying flow control to the radio access technologies of the selected subset.

28. A non-transitory computer-readable medium for use with a user equipment supporting a plurality of radio access technologies, the medium comprising instructions configured to cause one or more computing devices to:
determine whether a flow control condition is met;
select a subset of the plurality of radio access technologies, in response to determining that the flow control condition is met; and
apply flow control to the radio access technologies of the selected subset.
